(19) United States
(12) Patent Application Publication
(10) Pub. No.: US 2025/0248568 A1
(43) Pub. Date: Aug. 7, 2025

(54) LID ASSEMBLY, PORTABLE RECHARGEABLE BLENDER AND INSULATION CUP BODY

(71) Applicant: Shenzhen Deyi Innovation Technology Co.,Ltd., Shenzhen (CN)

(72) Inventor: Min Lv, Shenzhen (CN)

(21) Appl. No.: 18/671,313

(22) Filed: May 22, 2024

(30) Foreign Application Priority Data
Feb. 5, 2024 (CN) 202410171732.0
Feb. 5, 2024 (CN) 202420287432.4

(51) Int. Cl. A47J 43/07; A47J 41/02; A47J 43/044

(52) U.S. Cl. CPC A47J 43/0711; A47J 41/02; A47J 43/044; A47J 43/0755; A47J 2043/04427

(57) ABSTRACT

A lid assembly including a housing and a pulverizing device. The housing has a center axis and is adapted to close and seal a cup body of the blender. The pulverizing device is arranged in the housing and includes a pulverizing knife assembly and a driver configured to drive the pulverizing knife assembly to rotate. A rotation axis of the pulverizing knife assembly is offset from the center axis of the housing. The pulverizing knife assembly includes an upper knife, a lower knife, and an intermediate knife disposed between the upper knife and the lower knife, and the upper knife, the lower knife, and the intermediate knife are stacked in an axial direction. The intermediate knife comprises a first blade and a second blade extending in a radial direction, the first blade being inclined upwardly and the second blade being inclined downwardly.

### CROSS REFERENCE

The present disclosure claims priorities of Chinese Patent Applications No. 202420287432.4, filed on, 02/05/2024, and No. 202410171732.0 filed on, 02/05/2024, the entire contents of which are hereby incorporated by reference in their entirety.

### TECHNICAL FIELD

The present disclosure relates to technical field of life appliances, and in particular to a lid assembly, a portable blender and an insulation cup body.

### BACKGROUND

Portable blenders, also known as juice cups and milkshake cups, etc., can cut and pulverize ingredients, such as fruits, vegetables, and ice cubes, by mechanical methods to produce highly viscous fluid-like ingredients. The portable blenders are widely marketed in recent years due to their advantages of small size, easy operation, and portability.

The portable blender usually includes a lid assembly and a cup. The lid assembly is arranged with an electric motor, an output shaft of the electric motor is connected to a stirring knife. In operation, the electric motor drives the stirring knife to rotate at a high speed to complete cutting and pulverizing the ingredients in the cup. However, existing cup bodies are mostly made of glass or plastic, which have a poor warm-keeping and cold-keeping effect, causing the smoothies and ice shakes made to melt quickly. To ensure safety, a safety switch is arranged in a lid assembly, and the existing technology generally sets the safety switch on an end surface of the lid assembly. However, for some cup bodies, each cup body is arranged on the lid assembly by way of a sleeving connection, in which case the cup body as a whole is exposed, and there is no space to arrange the safety switch on the end surface of the lid assembly. Moreover, when there are food residues on the end face, even if the cup body is not mounted in place, there may be a false trigger situation due to the extrusion of the food residues on the safety switch, which affects the safety of the equipment. Moreover, it has been found in use that the existing portable blender does not have a satisfactory pulverizing and blending effect when pulverizing a frozen mixture, and that situations such as the smoothie particles are uneven, the particles are large, and the smoothie rate is low, etc. may occur.

Therefore, there is an urgent need for a lid assembly and a portable rechargeable blender and aninsulation cup body, with good pulverizing effect on the frozen mixture as well as an insulation effect to overcome the above defects.

### SUMMARY OF THE DISCLOSURE

It is an object of the present disclosure to provide a lid assembly to solve the problem of poor pulverization of frozen mixtures.

Another object of the present disclosure is to provide a portable blender to solve the problem of poor pulverization of frozen mixtures.

To achieve the first object, the present disclosure provides lid assembly, applied to a blender and configured to pulverize ingredients in the blender; wherein the lid assembly comprises: a housing, having a center axis and adapted to close and seal a cup body of the blender; and a pulverizing device, arranged in the housing and comprising a pulverizing knife assembly and a driver configured to drive the pulverizing knife assembly to rotate; wherein a rotation axis of the pulverizing knife assembly is offset from the center axis of the housing; the pulverizing knife assembly comprises an upper knife, a lower knife, and an intermediate knife disposed between the upper knife and the lower knife, and the upper knife, the lower knife, and the intermediate knife are stacked in an axial direction; the intermediate knife comprises a first blade and a second blade extending in a radial direction, the first blade being inclined upwardly and the second blade being inclined downwardly.

In some embodiments, the first blade has an inclination angle in a range from 5° to 11°, and the second blade has an inclination angle in a range from −5° to −11°.

In some embodiments, the first blade has an inclination angle of 8°, and the second blade has an inclination angle of −8°.

In some embodiments, a bottom end of the housing concavely defines an accommodating cavity, and the pulverizing knife assembly is arranged in the accommodating cavity; a spacing between an end portion of the first blade and a side wall of the accommodating cavity is not equal to a spacing between an end portion of the second blade and the side wall of the accommodating cavity.

In some embodiments, the spacing between the end portion of the second blade and the side wall of the accommodating cavity is in a range from 8.1 to 12 mm, and the spacing between the end portion of the first blade and the side wall of the accommodating cavity is in a range from 4 to 8 mm; a spacing between a middle portion of the second blade and a bottom of the accommodating cavity is in a range from 14 to 20 mm.

In some embodiments, the spacing between the end portion of the second blade and the side wall of the accommodating cavity is 10.45 mm, and the spacing between the end portion of the first blade and the side wall of the accommodating cavity is 7.17 mm; a spacing between a middle portion of the second blade and a bottom of the accommodating cavity is 17.7 mm.

In some embodiments, both ends of the upper knife are inclined upwardly, and both ends of the lower knife are inclined downwardly; an inclination angle of each end of the upper knife is greater than an inclination angle of each end of the lower knife.

In some embodiments, an inclination angle of each end of the upper knife is in a range from 51° to 60°, and an inclination angle of each end of the lower knife is in a range from −40° to −50°.

In some embodiments, an outer peripheral side of the housing is formed with an outer threaded structure, and the outer peripheral side of the housing is further formed with a stopper; the stopper and a peripheral side wall of the housing encloses to define a slot; a safety switch is embedded in the housing and is directly opposite to the stopper; in condition of the cup body being sleeved on the housing and connected to the outer threaded structure, a cup mouth of the cup body is stuck into the slot and triggers the safety switch; the housing has a mounting cavity and a discharge channel, the mounting cavity and the discharge channel being spaced apart, and the driver is arranged in the mounting cavity; the discharge channel is in communication with the accommodating cavity; the housing is arranged with a flip-top lid, the flip-top lid having at least an open state and a closed state; the flip-top lid in the closed state blocks the discharge channel; an outer side of the housing is arranged with a structural groove; a control switch and a charging interface are arranged at a bottom of the structural groove; the structural groove is fitted with a soft rubber protective pad; the structural groove is disposed below a hinged side of the flip-top lid; a signal light is arranged in the housing, the housing is further arranged with a light-transmitting sheet disposed above the signal light, and the flip-top lid is arranged with a light-guiding post, the light-guiding post being directly above the light-transmitting sheet in condition of the flip-top lid being in the closed state.

To achieve the other object, the present disclosure provides a portable blender, including: a cup body, having a cup mouth; and the lid assembly as above, capable of detachably closing and sealing the cup mouth of the cup body.

To achieve the other object, the present disclosure provides a portable rechargeable blender, including:
an insulation cup body, of a double-layer vacuum structure and having a cup mouth; wherein a plurality of spoiler ribs are formed on an inner side wall of the insulation cup body, and the plurality of spoiler ribs are vertically oriented and each are in a form of a protrusion with both ends narrower and a middle wider; and a lid assembly; wherein a rechargeable battery is arranged in the lid assembly; the lid assembly includes a housing and a pulverizing device arranged in the housing; the insulation cup body is capable of being arranged on the housing in a sleeving manner.

In some embodiments, a peripheral side of the housing defines a slot, and a safety switch is arranged in the housing; in condition of the insulation cup body being sleeved on the housing, the cup mouth is stuck into the slot and radially triggers the safety switch.

In some embodiments, the peripheral side of the housing is formed with a stopper, and the stopper and a peripheral side wall of the housing enclose to define the slot; the safety switch is embedded in the housing and is directly opposite to the stopper.

In some embodiments, a mounting cavity and a discharge channel are defined in the housing, and the mounting cavity and the discharge channel are spaced apart; the pulverizing device includes a driver and a pulverizing knife assembly, the driver being configured to drive the pulverizing knife assembly to rotate; the driver and the rechargeable battery are arranged in the mounting cavity; the housing is arranged with a flip-top lid, the flip-top lid having at least an open state and a closed state; the flip-top lid in the closed state blocks the discharge channel.

In some embodiments, a side of the flip-top lid is hingedly connected to the housing, and another side of the flip-top lid opposite to the side of the flip-top lid is detachably snap-fit to the housing; the flip-top lid in the open state is capable of being stopped at a flipping angle of 120° and/or 180°; a bottom of the flip-top lid is arranged with a plug, and the plug is inserted into the discharge channel in condition of the flip-top lid being in the closed state to close the discharge channel.

In some embodiments, an outer side of the housing is arranged with a structural groove; a control switch and/or a charging interface is arranged on a bottom of the structural groove; the structural groove is fitted with a soft rubber protective pad, and the structural groove is disposed below a hinged side of the flip-top lid.

In some embodiments, a signal light is arranged in the housing; the housing is further arranged with a light-transmitting sheet disposed above the signal light, and the flip-top lid is arranged with a light-guiding post, the light-guiding post being directly above the light-transmitting sheet in condition of the flip-top lid being in the closed state.

In some embodiments, the housing includes an upper structural portion and a lower structural portion; the lower structural portion extends into the insulation cup body in condition of the housing closing and sealing the cup mouth of the insulation cup body; an outer wall of the lower structural portion is formed with an outer threaded structure, and an inner threaded structure is formed on an inner wall of the cup mouth of the insulation cup body.

In some embodiments, an outer side of the lower structural portion is sleeved with a sealing ring, with at least a portion of the sealing ring abutting against the upper structural portion, and a remaining portion of the sealing ring being sleeved on the outer side of the lower structural portion.

To realize the other object, the present disclosure provides an insulation cup body, applied to a portable rechargeable blender; wherein the insulation cup body is of a double-layer vacuum structure; the insulation cup body includes an upper cup portion in a cylindrical shape and a lower cup portion in an inverted round platform shape; a plurality of spoiler ribs are formed on an inner side wall of the lower cup portion, and the plurality of spoiler ribs are vertically oriented and each are in a form of a protrusion with both ends narrower and a middle wider.

The present disclosure proposes an improvement to the structure of the pulverizing knife assembly, where the first blade is inclined upwardly and the second blade is inclined downwardly, such that in the cutting process the thrown up and falling ingredients can be cut first, and the cut ingredients become finer in size in the collision, which makes it easier to obtain a fine and uniform mixer, thereby realizing a more delicate texture. Further, the first blade and the second blade are in a top-and-bottom design, which may play a vortex effect on the pulverized ingredients to get a better mixing effect. Therefore, the present disclosure may provide a better pulverizing and mixing effect on frozen mixtures.

In the pulverizing and mixing process, the upper knife causes ingredients to be constantly rotated and thrown up such that the ingredients collide with the upper knife. The intermediate knife quickly cuts the ingredients rotated and thrown up by the upper knife and the lower knife during the pulverizing and mixing process, such that the ingredients are chopped and mixed more fully and more finely. In the pulverizing and mixing process, the lower knife causes the ingredients falling to the bottom to be quickly rotated and thrown up to the upper layer to achieve more adequate mixing with the knives.

Compared with the traditional knife assembly, the pulverizing knife assembly provided by the present disclosure includes additionally the S-shaped intermediate knife. For the knives with different angles of traditional knife assembly, the blending of ingredients is realized mainly depending on the collision with the ingredients and then cutting and mixing; due to the fact that its own rotational speed and torque is not very high, it is difficult to fully pulverize and mix the ingredients, such that a very delicate smoothie or milkshake is difficult to obtain. As a comparison, the pulverizing knife assembly of the present disclosure has a total of 6-blade knife edges, and by stacking the three layers of knives, the S-shaped knife in the middle can realize the rapid cutting of ingredients directly at the beginning of mixing, and when the ingredients are chopped into small pieces or small particles, it is easier to achieve a delicate mixing effect depending on the collision of high-speed and large-torque knives.

Compared to the related art, although the insulation cup body of the present disclosure is arranged in a sleeving manner, the safety switch is arranged in the housing and can be triggered in the radial direction, in which case there is space for the safety switch to be designed and mounted. In addition, when there is food residue left on an end surface of the lid assembly, because the safety switch can only be triggered in the radial direction, even if the insulation cup body is not mounted in place, the radial pressure generated by the pressed food is limited, and the safety switch cannot be triggered either. In this way, it is difficult to generate a false contact situation, thereby improving the safety of the equipment.

Further, the inner threaded structure is arranged on the inner wall of the cup mouth of the insulation cup body, such that the smoothie and milkshake can only be left in the inner threaded structure when the customer drinks, i.e., the smoothie and milkshake are still inside the cup, thereby avoiding overflowing and strengthening the hygiene and cleanliness and anti-pollution. In addition, the insulation cup body is a double-layer vacuum structure, which is made of metal material. The metal double-layer vacuum structure has high strength, good insulation effect, as well as excellent anti-frostbite and anti-scald function. The insulation cup body includes an upper cup portion in a cylindrical shape and a lower cup portion in an inverted round platform shape. The upper cup portion has a larger orifice, which is convenient for filling or pouring out the ingredients. The lower cup portion has an outer diameter decreasing downward, which is convenient for the user to hold. Further, multiple spoiler ribs are formed on an inner side wall of the lower cup portion, and the multiple spoiler ribs are vertically oriented and each are in a form of a protrusion with both ends narrower and a middle wider, such that the spoiler ribs can make the ingredients in an inner layer of the cup and an outer layer of the cup exchange in the process of pulverizing and blending, such that the pulverizing and blending is more uniform.

It will be appreciated that since the portable blender of the present disclosure includes the lid assembly described above, the present disclosure also has the advantages of good pulverization of frozen mixtures as well as good insulation effect.

### BRIEF DESCRIPTION OF THE DRAWINGS

FIG. 1 is a front view of a portable blender according to the present disclosure.

FIG. 2 is a side view of a portable blender according to the present disclosure.

FIG. 3 is a perspective view of a portable blender with a lid assembly removed from an insulation cup body according to the present disclosure.

FIG. 4 is a perspective view of a lid assembly with a carrying strap concealed and removed from a soft rubber protective pad according to the present disclosure.

FIG. 5 is a perspective view of a lid assembly with a flip-top lid in a closed state according to the present disclosure.

FIG. 6 is a perspective view of a lid assembly with a flip-top lid in an open state according to the present disclosure.

FIG. 7 is a perspective view of a lid assembly according to the present disclosure.

FIG. 8 is a bottom view of a lid assembly with a carrying strap concealed according to the present disclosure.

FIG. 9 is a perspective view of a lid assembly with a carrying strap concealed according to the present disclosure.

FIG. 10 is a perspective view of a pulverizing knife assembly according to the present disclosure.

FIG. 11 is a front view of a pulverizing knife assembly according to the present disclosure.

FIG. 12 is a side view of a pulverizing knife assembly according to the present disclosure.

FIG. 13 is a cross-sectional view along a line E-E in FIG. 2.

FIG. 14 is a perspective view of an insulation cup body according to the present disclosure.

FIG. 15 is a front view of an insulation cup body according to the present disclosure.

FIG. 16 is a cross-sectional view along a line F-F in FIG. 15.

FIG. 17 is a comparative image view of smoothies made by the portable blender according to the present disclosure and a commercially available product.

### DETAILED DESCRIPTION

In order to illustrate the technical contents and constructional features of the present disclosure in detail, the following is further described in combination with the embodiments and with the accompanying drawings.

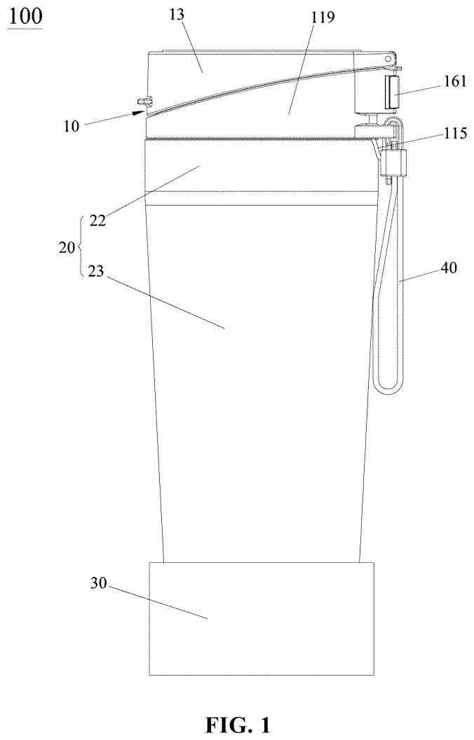

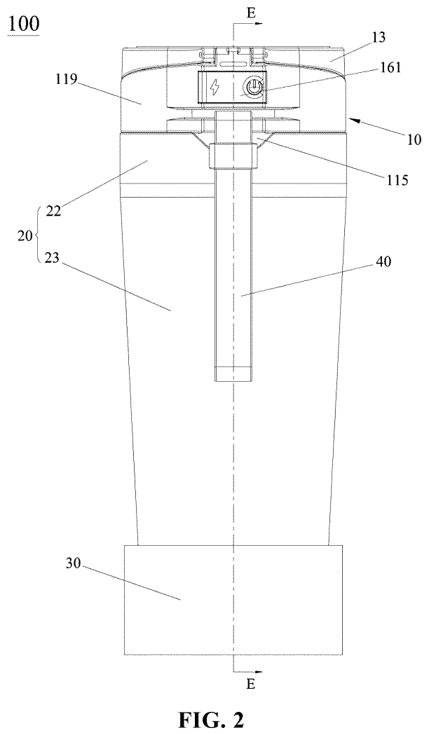

As shown in FIGS. 1 and 2, the present disclosure provides a portable blender 100, which has an overall compact size, a shape and structure similar to that of an ordinary water cup, is easy to carry, and can be recharged for use in many application scenarios. The portable blender 100 includes a lid assembly 10 and a cup body having a cup mouth, the cup body being specifically an insulation cup body 20, and the lid assembly 10 being capable of detachably closing and sealing the cup mouth of the insulation cup body 20. The insulation cup body 20 has good heat insulation properties and can play a warm-keeping/cold-keeping role for ingredients filled therein, e.g., playing a cold-keeping role for ice-smoothies, ice shakes, etc., and playing a warm-keeping role for hot soymilk, hot coffee, etc.

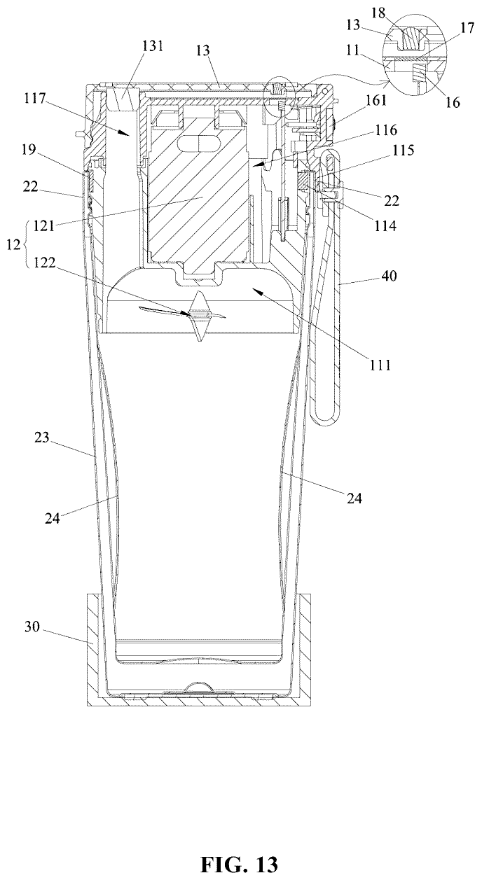

When the portable blender 100 is in use, the lid assembly 10 is first separated from the insulation cup body 20, ingredients are added to the insulation cup body 20, and the lid assembly 10 is snapped onto the cup mouth of the insulation cup body 20. A pulverizing knife assembly 122 (shown in FIG. 13) is arranged inside the insulation cup body 20, and the pulverizing knife assembly 122 is activated to pulverize and blend the ingredients.

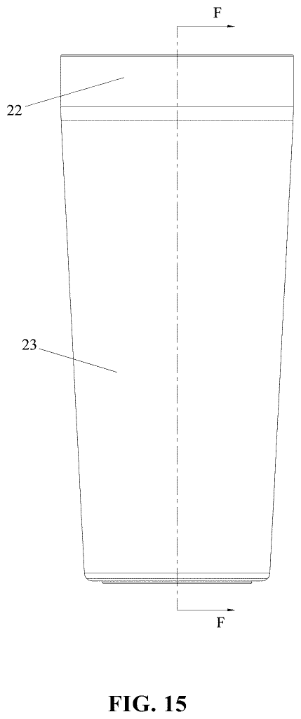

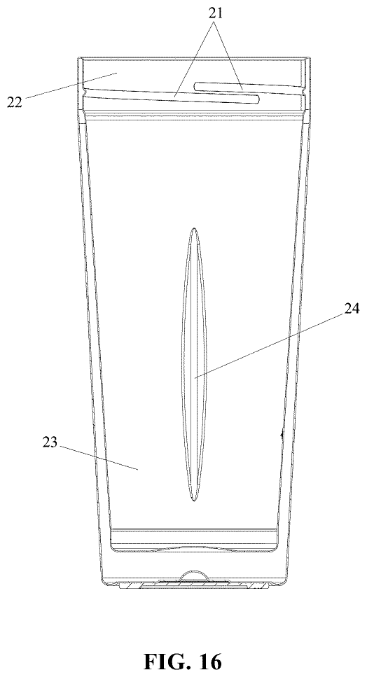

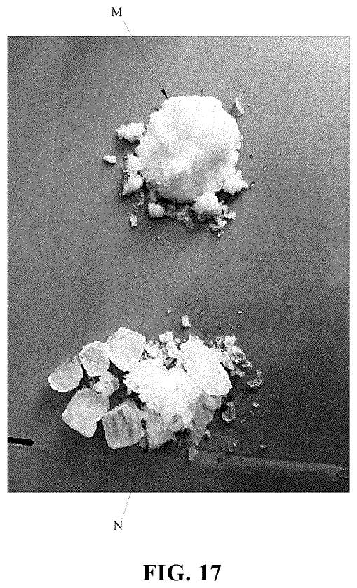

The portable blender 100 has a built-in rechargeable battery, for being used in a mobile manner. Of course, according to actual needs, the portable blender 100 can be designed for plug-in use. As shown in FIGS. 10, 11, 15 and 16, The insulation cup body 20 may be of a double-layer vacuum structure, which is made of metal material, an outer layer of the insulation cup body 20 is made of 201 stainless steel, while an inner layer is made of 304 stainless steels, etc. Alternatively, the insulation cup body 20 may be made of plastic material or glass material. The metal double-layer vacuum structure has high strength, good insulation effect, as well as excellent anti-frostbite and anti-scald function. An upper end of the insulation cup body 20 forms the cup mouth for adding ingredients or liquids, also for pouring out the ingredients and liquids.

In the occasion of pulverizing and blending the ingredients, the portable blender 100 is required to be placed upside down, or tilted at a certain angle, such that the insulation cup body 20 is on the top and the lid assembly 10 is on the bottom. In this way, the ingredients inside the insulation cup body 20 can fall to the pulverizing knife assembly 122 by gravity, so as to facilitate pulverizing and blending of the ingredients.

The portable blender 100 may be applied to make smoothies, ice shakes, ice juices, and of course soy milk, rice pudding, coffee, and ground meat sauces, etc.

As shown in FIGS. 1, 2, and 3, an inner threaded structure 21 is formed on an inner wall of the cup mouth of the insulation cup body 20, such that the insulation cup body 20 can be connected to the lid assembly 10 through the inner threaded structure 21. The insulation cup body 20 includes an upper cup portion 22 of a cylindrical structure and a lower cup portion 23 of an inverted round platform structure. The upper cup portion 22 has a larger orifice, which is convenient for filling or pouring out the ingredients. The lower cup portion 23 has an outer diameter gradually decreasing downward, which is convenient for the user to hold. In order to enhance the stability of the portable blender 100, the portable blender 100 further includes a cup holder 30, which is fitted to a lower end of the lower cup portion 23. The cup holder 30 is substantially cylindrical, but is not limited to that form. The cup holder 30 may increase the contact area, thereby allowing the portable blender 100 to be placed more stably.

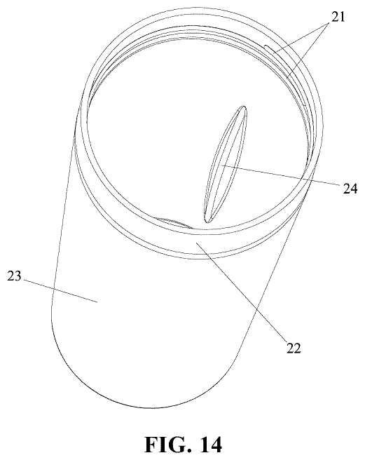

As shown in FIGS. 14-16, multiple spoiler ribs 24 are formed on an inner side wall of the insulation cup body 20, and the multiple spoiler ribs 24 are vertically oriented and each are in a form of a protrusion with both ends narrower and a middle wider, such that the spoiler ribs 24 can make the ingredients in an inner layer of the cup and an outer layer of the cup exchange in the process of pulverizing and blending, such that the pulverizing and blending is more uniform.

The lid assembly 10 of the present disclosure is described in detail below.

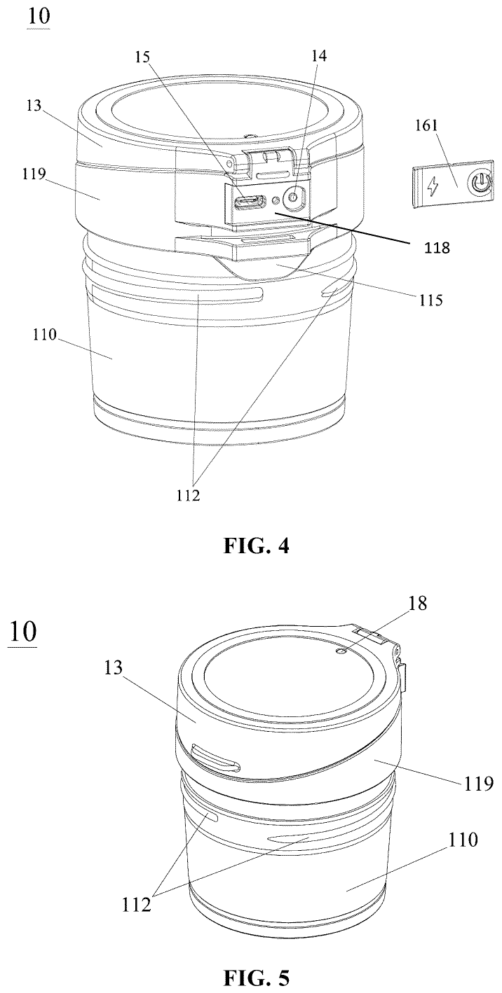

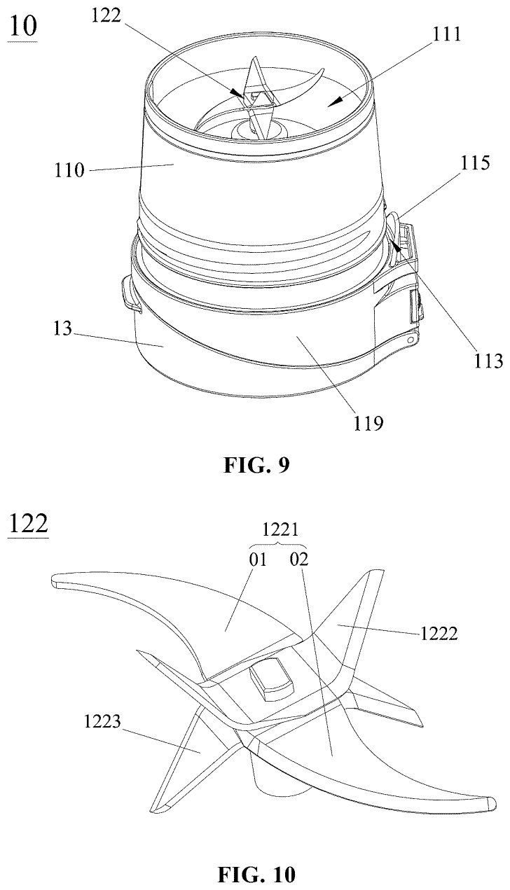

As shown in FIGS. 4 to 13, the lid assembly 10 includes a housing 11 and a pulverizing device 12. The housing 11 may be made of plastic material, but is not limited thereto. The housing 11 has a center axis B. The housing 11 is adapted to close and seal the insulation cup body 20, and the insulation cup body 20 is arranged on the housing 11 in a sleeving manner (i.e., the insulation cup body 20 can be sleeved on the housing 11).

The pulverizing device 12 is disposed in the housing 11, and the pulverizing device 12 includes a driver 121 and the pulverizing knife assembly 122, the driver 121 being configured to drive the pulverizing knife assembly 122 to rotate. The driver 121 is disposed inside the housing 11, while the pulverizing knife assembly 122 is disposed outside the housing 11.

In some embodiments, as shown in FIG. 8, a rotation axis A of the pulverizing knife assembly 122 is offset from the center axis B of the housing 11, which helps to pulverize and mix ingredients more efficiently, such that finer pulverization can be realized with less rotation. The driver 121 may be an electric motor, and the pulverizing knife assembly 122 is arranged to an output end of the driver 121, such that the driver 121 can drive the pulverizing knife assembly 122 to rotate.

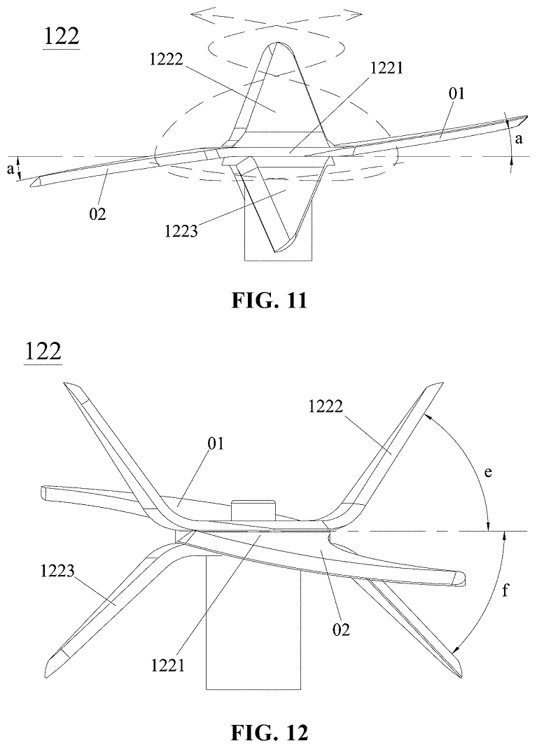

As shown in FIG. 10, FIG. 11, and FIG. 12, the pulverizing knife assembly 122 includes an upper knife 1222, a lower knife 1223, and an intermediate knife 1221 disposed between the upper knife 1222 and the lower knife 1223. The upper knife 1222, the lower knife 1223, and the intermediate knife 1221 are stacked in an axial direction. The intermediate knife 1221 includes a first blade 01 and a second blade 02 extending in a radial direction, the first blade 01 being inclined upwardly and the second blade 02 being inclined downwardly.

The present disclosure proposes an improvement to the structure of the pulverizing knife assembly 122, where the first blade 01 is inclined upwardly and the second blade 02 is inclined downwardly, such that in the cutting process the thrown up and falling ingredients can be cut first, and the cut ingredients become finer in size in the collision, which makes it easier to obtain a fine and uniform mixer, thereby realizing a more delicate texture. Further, the first blade 01 and the second blade 02 are in a top-and-bottom design, which may play a vortex effect on the pulverized ingredients to get a better mixing effect. Therefore, the present disclosure may provide a better pulverizing and mixing effect on frozen mixtures. The pulverizing knife assembly 122 in the above embodiments includes 3 sets of knives, but it should be understood that 4, 5, 6, 7, 8 or more sets of knives may be designed according to actual needs. The first blade 01 and the second blade 02 have knife edges to cut and pulverize the ingredients. It is to be understood that by using more knives, there will be more points of contact to pulverize and strike the ice at the same time, which reduces the likelihood of only pushing without pulverizing/destroying.

As shown in FIG. 11, the first blade 01 has an inclination angle in a range from 5° to 11° and the second blade 02 has an inclination angle in a range from −5° to −11°. In some embodiments, the value of the inclination angle α of the first blade 01 is the same as the value of the inclination angle α of the second blade 02, with the first blade 01 tilted upward by 8° and the second blade 02 tilted downward by −8°, which helps to ensure rotational stability.

As shown in FIGS. 8 and 10, the first blade 01 and the second blade 02 are bent structures and are arranged in a diagonally symmetric manner. In the above embodiments provided by the present disclosure, the intermediate knife 1221 is generally in the shape of an “S” shape, but it is not limited thereto. The knife edges of the first blade 01 and the second blade 02 are set on different sides, where the knife edge of the second blade 02 is facing upward and the knife edge of the first blade 01 is facing downward. The knife edges of the first blade 01 and the second blade 02 can cut and pulverize the ingredients in different layers, so as to pulverize and stir the ingredients more evenly.

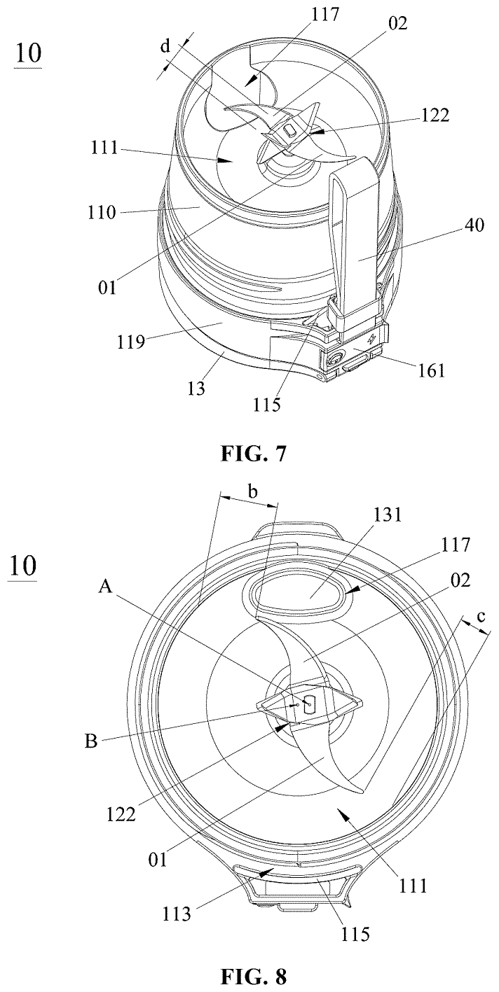

As shown in FIGS. 7, 8, and 9, a bottom end of the housing 11 concavely defines an accommodating cavity 111, and the pulverizing knife assembly 122 is arranged in the accommodating cavity 111. A spacing between an end portion of the first blade 01 and a side wall of the accommodating cavity 111 is not equal to a spacing between an end portion of the second blade 02 and the side wall of the accommodating cavity 111. Specifically, the spacing b between the end portion of the second blade 02 and the side wall of the accommodating cavity 111 is in a range from 8.1 to 12 mm, such as 10.45 mm, and the spacing c between the end portion of the first blade 01 and the side wall of the accommodating cavity 111 is in a range from 4 to 8 mm, such as 7.17 mm.

As shown in FIG. 7, a spacing d between a middle portion of the second blade 02 and a bottom of the accommodating cavity 111 is in a range from 14-20 mm, such as 17.7 mm.

The above-mentioned upward and downward directions are determined after the lid assembly 10 is placed upside down. In use, after the portable blender 100 is placed upside down, the upper knife 1222 is located above the lower knife 1223. In this way, the upper knife 1222 pulverizes, cuts, and blends the ingredients located above it, and the lower knife 1223 pulverizes, cuts, and blends the ingredients located above it.

In the pulverizing and mixing process, the upper knife 1222 causes ingredients to be constantly rotated and thrown up such that the ingredients collide with the upper knife 1222. The intermediate knife 1221 quickly cuts the ingredients rotated and thrown up by the upper knife 1222 and the lower knife 1223 during the pulverizing and mixing process, such that the ingredients are chopped and mixed more fully and more finely. In the pulverizing and mixing process, the lower knife 1223 causes the ingredients falling to the bottom to be quickly rotated and thrown up to the upper layer to achieve more adequate mixing with the knives.

Compared with the traditional knife assembly, the pulverizing knife assembly 122 provided by the present disclosure includes additionally the S-shaped intermediate knife 1221. For the knives with different angles of traditional knife assembly, the blending of ingredients is realized mainly depending on the collision with the ingredients and then cutting and mixing; due to the fact that its own rotational speed and torque is not very high, it is difficult to fully pulverize and mix the ingredients, such that a very delicate smoothie or milkshake is difficult to obtain. As a comparison, the pulverizing knife assembly 122 of the present disclosure has a total of 6-blade knife edges, and by stacking the three layers of knives, the S-shaped knife in the middle can realize the rapid cutting of ingredients directly at the beginning of mixing, and when the ingredients are chopped into small pieces or small particles, it is easier to achieve a delicate mixing effect depending on the collision of high-speed and large-torque knives.

In some embodiments, as shown in FIG. 12, an inclination angle e of each end of the upper knife 1222 is greater than an inclination angle f of each end of the lower knife 1223. The angle e is designed to be greater than the angle f, such that when mixing harder ingredients, the ingredients can be continuously thrown up to be cut and collided with, and it is not easy to get stuck in the knife, and thus it is easier to obtain a good pulverizing and blending effect. By virtue of the pulverizing knife assembly 122 of the present disclosure, the ingredients can be pulverized and blended more uniformly and finely, such that the ingredients obtained are more delicate.

As shown in FIG. 17, an experimentation is conducted by using the portable blender 100 of the present disclosure and a product available in the market manufactured by Brandjet Ltd. Under similar output power as well as the room temperature environment, 8 ice cubes (size of 2.5 cm×2.5 cm×2.5 cm) are put into the two products, for pulverizing and churning for about 30s to get the two piles of smoothies. As shown in FIG. 17, the upper arrow M indicates the smoothie obtained by the portable blender 100 of the present disclosure, the lower arrow N indicates the smoothie obtained by comparative manufacturer. As can be seen, the smoothie indicated by the arrow M is more homogeneous, and the particle size is smaller, such that customers can obtain a more delicate and smooth texture without chewing to swallow. The smoothie indicated by the arrow N is unevenly coarse, and the particle size is larger, such that the taste is not good when consumed and needs to be chewed. It can be seen that better results are indeed achieved using the pulverizing knife assembly 122 of the present disclosure.

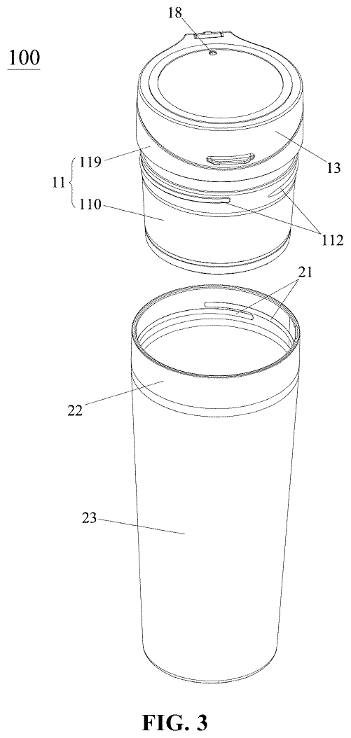

As shown in FIGS. 3, 13 and 14, an outer peripheral side of the housing 11 is formed with an outer threaded structure 112. When the lid assembly 10 is capped onto the cup mouth of the insulation cup body 20, the screwed connection between the outer threaded structure 112 and the inner threaded structure 21 makes an effective and stable connection between the lid assembly 10 and the insulation cup body 20, which helps to ensure the sealing of the connection. In addition, the inner threaded structure 21 is arranged on the inner wall of the cup mouth of the insulation cup body 20, such that the smoothie and milkshake can only be left in the inner threaded structure 21 when the customer drinks, i.e., the smoothie and milkshake are still inside the cup, thereby avoiding overflowing and strengthening the hygiene and cleanliness and anti-pollution.

As shown in FIGS. 1, 2, 7, 8, 9, and 13, a peripheral side of the housing 11 defines a slot 113, and a safety switch 114 is arranged in the housing 11. When the insulation cup body 20 is sleeved on the housing 11 and connected to the outer threaded structure 112, the mouth end is stuck into the slot 113 and triggers the safety switch 114, which represents that the insulation cup body 20 has been installed in place and the blender is ready to be turned on to perform the pulverizing and churning. Conversely, when the safety switch 114 is not triggered, the insulation cup body 20 is not in place and cannot perform the pulverizing. Although the insulation cup body 20 is arranged in a sleeving manner, in the present disclosure, the safety switch 114 is arranged in the housing 11 and can be triggered in the radial direction, in which case there is space for the safety switch 114 to be designed and mounted. In addition, when there is food residue left on an end surface of the lid assembly, because the safety switch 114 can only be triggered in the radial direction, even if the insulation cup body 20 is not mounted in place, the radial pressure generated by the pressed food is limited, and the safety switch 114 cannot be triggered either. In this way, it is difficult to generate a false contact situation, thereby improving the safety of the equipment.

In some embodiments, the peripheral side of the housing 11 is formed with a stopper 115, and the stopper 115 and a peripheral side wall of the housing 11 encloses to define the slot 113. The safety switch 114 is embedded in the housing 11 and is directly opposite to the stopper 115. Only after the insulation cup body 20 is normally installed in place can the safety switch 114 be triggered, thereby avoiding false activation due to accidental touch, and thus strengthening the safety of use. The safety switch 114 may be adopted with a mechanical switch, and of course may be adopted with a photoelectric switch or the like. It is to be noted that the width of the stopper 115 is limited and does not belong to an annular structure, which is generally in the shape of an arc sheet. Therefore, the food residue in the slot 113 can be quickly drained when squeezed, thereby reducing the likelihood of being pressed.

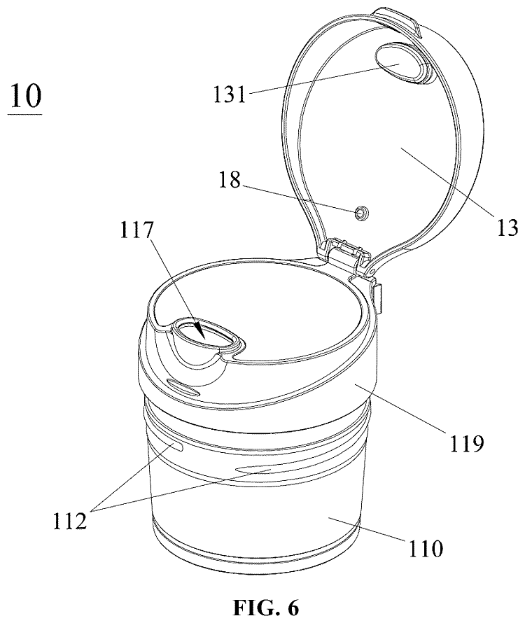

As shown in FIGS. 6-8, and 13, the housing 11 has a mounting cavity 116 and a discharge channel 117, the mounting cavity 116 and the discharge channel 117 are spaced apart. The pulverizing device 12 includes a driver 121 and the pulverizing knife assembly 122, the driver 121 being configured to drive the pulverizing knife assembly 122 to rotate, and the driver 121 is arranged in the mounting cavity 116. The discharge channel 117 is configured for the outflow of the ingredients in the cup. The orifice of the discharge channel 117 may be designed as desired. The ingredients in the cup are fluidized after mixing, such that the ingredients such as smoothies and ice shakes can be poured out through the discharge channel 117 without removing the lid assembly 10. The discharge channel 117 is in communication with the accommodating cavity 111. The rechargeable battery (not labeled) is arranged in the mounting cavity 116. Further, a control circuit board, wires, and other structures are arranged in the mounting cavity 116.

The housing 11 is arranged with a flip-top lid 13, the flip-top lid 13 having at least an open state as shown in FIG. 6 and a closed state as shown in FIG. 5. The flip-top lid 13 in the closed state blocks the discharge channel 117. Further, a side of the flip-top lid 13 is hingedly connected to the housing 11, and the other side opposite thereto of the flip-top lid 13 is detachably snap-fit to the housing 11. A bottom of the flip-top lid 13 is arranged with a plug 131, which is inserted into the discharge channel 117 when the flip-top lid 13 is in the closed state as shown in FIG. 6 and FIG. 8, to close the discharge channel 117. The housing 11 is arranged with a tab at a hinged joint with the flip-top lid 13, the flip-top lid 13 being hingedly connected to the tab, which enables the flip-top lid 13 to be flipped 120° or 180° and stopped in the open state, such that the flip-top lid 13 will not touch the head or nose of the customer when the customer is drinking,.

As shown in FIGS. 2 and 4, an outer side of the housing 11 is arranged with a structural groove 118. A control switch 14 and a charging interface 15 are arranged at a bottom of the structural groove 118. The control switch 14 is configured for controlling the power-on and working gears, etc., for example, controlling the power and rotational speed of the pulverizing knife assembly 122. The charging interface 15 may be adopted with a Type-C interface, a Micro USB interface, a Lighting interface, etc., but of course the interface is not necessary and may be charged by adopting a non-connectorized method such as magnetic charging.

As shown in FIG. 13, the rechargeable battery (not labeled) is arranged in the mounting cavity 116. Further, a control circuit board, wires, and other structures are arranged in the mounting cavity 116.

As shown in FIGS. 1, 2, 4, 7-9, and 13, the structural groove 118 is fitted with a soft rubber protective pad 161, which serves to protect, dustproof, and protect. The soft rubber protective pad 161 may be printed with a “charging” pattern and a “power” pattern, but is not limited thereto. The structural groove 118 is disposed below a hinged side of the flip-top lid 13, such that the control switch 14 can still be operated when the flip-top lid 13 is opened, which is convenient for operation. In addition, the stopper 115 is disposed below the structural groove 118, in which case the hinged side of the flip-top lid 13, the structural groove 118, and the stopper 115 are disposed on the same side, which helps to improve the structural layout and aesthetics. In addition, a carrying strap 40 is further arranged on the housing 11, and the carrying strap 40 is also arranged on the same side as the stopper 115, but not limited thereto, by which the carrying strap 40 can facilitate the carrying of the blender 100.

As shown in FIGS. 3, 5, 6, and 13, a signal light 16 is arranged in the housing 11, the housing 11 is further arranged with a light-transmitting sheet 17 disposed above the signal light 16, and the flip-top lid 13 is arranged with a light-guiding post 18, the light-guiding post 18 being directly above the light-transmitting sheet 17 when the flip-top lid 13 is in the closed state. The light-transmitting sheet 17 and the light-guiding post 18 may help to transmit light from the signal light 16. The signal light 16 may be configured to emit light in a variety of colors (red, blue, etc.) and/or manners (normally bright, fast blinking, slow blinking, alternating red and blue, etc.). The signaling light 16 may communicate to a user about an operational status of the blender. The signal light 16 may be controlled by the control circuit board.

For example, when the signal light 16 is normally illuminated in red, it indicates that the blender is charging and/or that the power is insufficient for blending. When the signal light 16 is normally illuminated in blue, it indicates that the blender is ready to for blending. Other forms of operation of the signal light 16 may be designed as desired.

As shown in FIGS. 1-7, 9, and 12, the housing 11 includes an upper structural portion 119 and a lower structural portion 110. The lower structural portion 110 extends inside the insulation cup body 20 when the lid assembly 10 is capped over the cup mouth of the insulation cup body 20. In some embodiments, the safety switch 114 is embedded in the lower structural portion 110, and the stopper 115 is disposed on a side of the lower structural portion 110. The stopper 115 and the safety switch enclose to define the slot 113. As shown in FIG. 13, an outer side of the lower structural portion 110 is sleeved with a sealing ring 19, with at least a portion of the sealing ring 19 abutting against the upper structural portion 119, and a remaining portion of the sealing ring 19 being sleeved on the outer side of the lower structural portion 110. The sealing ring 19 serves as both an end seal and a side seal to strengthen the sealing between the lid assembly 10 and the insulation cup body 20.

The above is only some embodiments of the present disclosure and cannot be intended to limit the scope of the present disclosure. Therefore, the equivalent changes made in accordance with the claims of the present disclosure are within the scope of the present disclosure.

What is claimed is:

1. A lid assembly, applied to a blender and configured to pulverize ingredients in the blender;
wherein the lid assembly comprises:
a housing, having a center axis and adapted to close and seal a cup body of the blender; and
a pulverizing device, arranged in the housing and comprising a pulverizing knife assembly and a driver configured to drive the pulverizing knife assembly to rotate; wherein a rotation axis of the pulverizing knife assembly is offset from the center axis of the housing; the pulverizing knife assembly comprises an upper knife, a lower knife, and an intermediate knife disposed between the upper knife and the lower knife, and the upper knife, the lower knife, and the intermediate knife are stacked in an axial direction; the intermediate knife comprises a first blade and a second blade extending in a radial direction, the first blade being inclined upwardly and the second blade being inclined downwardly.

2. The lid assembly according to claim 1, wherein the first blade has an inclination angle in a range from 5° to 11°, and the second blade has an inclination angle in a range from −5° to −11°.

3. The lid assembly according to claim 1, wherein the first blade has an inclination angle of 8°, and the second blade has an inclination angle of −8°.

4. The lid assembly according to claim 1, wherein a bottom end of the housing concavely defines an accommodating cavity, and the pulverizing knife assembly is arranged in the accommodating cavity; a spacing between an end portion of the first blade and a side wall of the accommodating cavity is not equal to a spacing between an end portion of the second blade and the side wall of the accommodating cavity.

5. The lid assembly according to claim 4, wherein the spacing between the end portion of the second blade and the side wall of the accommodating cavity is in a range from 8.1 to 12 mm, and the spacing between the end portion of the first blade and the side wall of the accommodating cavity is in a range from 4 to 8 mm; a spacing between a middle portion of the second blade and a bottom of the accommodating cavity is in a range from 14 to 20 mm.

6. The lid assembly according to claim 4, wherein the spacing between the end portion of the second blade and the side wall of the accommodating cavity is 10.45 mm, and the spacing between the end portion of the first blade and the side wall of the accommodating cavity is 7.17 mm; a spacing between a middle portion of the second blade and a bottom of the accommodating cavity is 17.7 mm.

7. The lid assembly according to claim 1, wherein both ends of the upper knife are inclined upwardly, and both ends of the lower knife are inclined downwardly; an inclination angle of each end of the upper knife is greater than an inclination angle of each end of the lower knife.

8. The lid assembly according to claim 1, wherein an inclination angle of each end of the upper knife is in a range from 51° to 60°, and an inclination angle of each end of the lower knife is in a range from −40° to −50°.

9. The lid assembly according to claim 1, wherein an outer peripheral side of the housing is formed with an outer threaded structure, and the outer peripheral side of the housing is further formed with a stopper; the stopper and a peripheral side wall of the housing encloses to define a slot; a safety switch is embedded in the housing and is directly opposite to the stopper; in condition of the cup body being sleeved on the housing and connected to the outer threaded structure, a cup mouth of the cup body is stuck into the slot and triggers the safety switch;
the housing has a mounting cavity and a discharge channel, the mounting cavity and the discharge channel being spaced apart, and the driver is arranged in the mounting cavity; the discharge channel is in communication with the accommodating cavity;
the housing is arranged with a flip-top lid, the flip-top lid having at least an open state and a closed state; the flip-top lid in the closed state blocks the discharge channel;
an outer side of the housing is arranged with a structural groove; a control switch and a charging interface are arranged at a bottom of the structural groove; the structural groove is fitted with a soft rubber protective pad; the structural groove is disposed below a hinged side of the flip-top lid;
a signal light is arranged in the housing, the housing is further arranged with a light-transmitting sheet disposed above the signal light, and the flip-top lid is arranged with a light-guiding post, the light-guiding post being directly above the light-transmitting sheet in condition of the flip-top lid being in the closed state.

10. A portable blender, comprising:
a cup body, having a cup mouth; and
the lid assembly according to claim 1, capable of detachably closing and sealing the cup mouth of the cup body.

11. A portable rechargeable blender, comprising:
an insulation cup body, of a double-layer vacuum structure and having a cup mouth; wherein a plurality of spoiler ribs are formed on an inner side wall of the insulation cup body, and the plurality of spoiler ribs are vertically oriented and each are in a form of a protrusion with both ends narrower and a middle wider; and
a lid assembly; wherein a rechargeable battery is arranged in the lid assembly; the lid assembly comprises a housing and a pulverizing device arranged in the housing; the insulation cup body is capable of being arranged on the housing in a sleeving manner.

12. The portable rechargeable blender according to claim 11, wherein a peripheral side of the housing defines a slot, and a safety switch is arranged in the housing; in condition of the insulation cup body being sleeved on the housing, the cup mouth is stuck into the slot and radially triggers the safety switch.

13. The portable rechargeable blender according to claim 12, wherein the peripheral side of the housing is formed with a stopper, and the stopper and a peripheral side wall of the housing enclose to define the slot; the safety switch is embedded in the housing and is directly opposite to the stopper.

14. The portable rechargeable blender according to claim 11, wherein a mounting cavity and a discharge channel are defined in the housing, and the mounting cavity and the discharge channel are spaced apart; the pulverizing device comprises a driver and a pulverizing knife assembly, the driver being configured to drive the pulverizing knife assembly to rotate; the driver and the rechargeable battery are arranged in the mounting cavity; the housing is arranged with a flip-top lid, the flip-top lid having at least an open state and a closed state; the flip-top lid in the closed state blocks the discharge channel.

15. The portable rechargeable blender according to claim 14, wherein a side of the flip-top lid is hingedly connected to the housing, and another side of the flip-top lid opposite to the side of the flip-top lid is detachably snap-fit to the housing; the flip-top lid in the open state is capable of being stopped at a flipping angle of 120° and/or 180°; a bottom of the flip-top lid is arranged with a plug, and the plug is inserted into the discharge channel in condition of the flip-top lid being in the closed state to close the discharge channel.

16. The portable rechargeable blender according to claim 14, wherein an outer side of the housing is arranged with a structural groove; a control switch and/or a charging interface is arranged on a bottom of the structural groove; the structural groove is fitted with a soft rubber protective pad, and the structural groove is disposed below a hinged side of the flip-top lid.

17. The portable rechargeable blender according to claim 14, wherein a signal light is arranged in the housing; the housing is further arranged with a light-transmitting sheet disposed above the signal light, and the flip-top lid is arranged with a light-guiding post, the light-guiding post being directly above the light-transmitting sheet in condition of the flip-top lid being in the closed state.

18. The portable rechargeable blender according to claim 11, wherein the housing comprises an upper structural portion and a lower structural portion; the lower structural portion extends into the insulation cup body in condition of the housing closing and sealing the cup mouth of the insulation cup body; an outer wall of the lower structural portion is formed with an outer threaded structure, and an inner threaded structure is formed on an inner wall of the cup mouth of the insulation cup body.

19. The lid assembly according to claim 18, wherein an outer side of the lower structural portion is sleeved with a sealing ring, with at least a portion of the sealing ring abutting against the upper structural portion, and a remaining portion of the sealing ring being sleeved on the outer side of the lower structural portion.

20. An insulation cup body, applied to a portable rechargeable blender; wherein the insulation cup body is of a double-layer vacuum structure; the insulation cup body comprises an upper cup portion in a cylindrical shape and a lower cup portion in an inverted round platform shape; a plurality of spoiler ribs are formed on an inner side wall of the lower cup portion, and the plurality of spoiler ribs are vertically oriented and each are in a form of a protrusion with both ends narrower and a middle wider.
